(19) United States
(12) Patent Application Publication
(10) Pub. No.: US 2004/0089463 A1
(43) Pub. Date: May 13, 2004

(54) Coupling sleeve for a mineral-insulated cable and connection method

(76) Inventors: Coralie Nguyen, Noisy Le Grand (FR); Jean-Louis Tourraine, Auch (FR)

Correspondence Address: PERMAN & GREEN, 425 POST ROAD, FAIRFIELD, CT, 06824, US

(21) Appl. No.: 10/616,386

(22) Filed: Jul. 9, 2003

Related U.S. Application Data
(63) Continuation of application No. 10/301,319, filed on Nov. 21, 2002, now abandoned.

(30) Foreign Application Priority Data
Nov. 22, 2001 (FR) 01/15147

(51) Int. Cl. H02G 15/22; H01B 13/20; H01R 43/02

(52) U.S. Cl. 174/21 JC; 29/860; 29/828; 29/868; 174/19

(57) ABSTRACT

Coupling sleeve with a generally cylindrical shape designed for connection between a mineral-insulated coaxial cable and a matching device which is itself coaxial. The sleeve protects a first contact and directly provides a second contact between two ends respectively of the cable and of the matching device. The sleeve is preferably designed with an aperture to enable filling after final assembly. The filling is done with insulating materials. After filling, the aperture is plugged. Preferably, the sleeve is soldered respectively to the second contact of the cable and to the second contact of the matching device.

### BACKGROUND OF THE INVENTION

1. Field of the Invention

An object of the present invention is a coupling sleeve for a mineral-insulated cable. An object of the invention is also a method for the connection of a cable of this kind by means of a coupling sleeve. A mineral-insulated cable is made without plastic. Mineral-resistant cables are special fire-resistant cables used in places open to the public (such as shopping malls, airports, reception rooms etc.) or in industrial environments with high-risk areas such as nuclear power stations. However, such cables can be used to connect devices spaced out from one another. Means therefore have to be provided to connect these cables to the devices, or even to connect cables to one another. In a preferred embodiment, the mineral-insulated cable is coaxial. A means therefore has to be provided for the coaxial coupling of this mineral-insulated cable with a matching coaxial device. The value of the invention is that it presents a coupling means that is simple to make and simple to connect on both sides.

2. Brief Description Of Related Developments

In the prior art, the document GB-A-674,443 teaches a known connector designed to be mounted at one end of a cable, such that the cable has an insulation made out of a mineral material. According to the document, the connector is tubular and designed to be mounted, firstly, about one end of a first mineral-insulated cable and, secondly, about a second end of a second cable of this type. For this purpose, the ends are partially stripped so that each of them has an electrical contact matching the other, these two contacts being designed to be connected together. This connection is made inside the hollow body of the connector.

This connector body furthermore has an aperture to enable the unoccupied space of the hollow of the connector to be filled with a filler material. After filling, a nut is screwed into this aperture so as to plug it. According to this document, a connector poses a problem. Indeed, when the inner space of the connector is filled, there may be leaks at the entry and exit ends of the connector where the ends of the cables are inserted respectively.

Furthermore, in the prior art, there is also the known teaching of the document BE-A-654.939 which describes a connector designed to connect mineral-insulated cables also known as “MI cables”.

According to this document, a link between two ends of two MI cables is made by connecting two inner contacts of each of these cables together. Furthermore, a connection zone of the two cables is surrounded with a covering. This covering is tube-shaped and has a longitudinal aperture throughout the length. Two ends of this tube respectively embrace non-stripped cable portions. This longitudinal opening facilitates access into this tube through which the contacts connected to each other are presented. To insulate this connection, an insulating material is injected therein from the aperture.

Then, to ensure tight sealing, a second cylindrical sleeve which has total hermetic sealing is slid around the same zone. To provide for the tight sealing of the interconnection made, this second sleeve is preferably crimped about each of the two stripped MI cables respectively.

The drawback of such a system is that it requires the presence of two tube-shaped structures around the connection zone. Indeed, a first tube serves to come into direct contact with the external sheaths of the connected contacts so as to encircle the connection zone. Furthermore, this first cylindrical tube has the aperture to enable filling with an insulating material. However, given its size, the aperture poses a problem and therefore requires the presence of a second cylindrical sleeve around this first zone to ensure the general tight sealing of the interconnection.

### SUMMARY OF THE INVENTION

The solution proposed according to this invention poses a problem. Indeed, to limit the problems of leaks on either side of the sleeve, it is planned to make a longitudinal aperture from which it is easy to insert the insulator material in the right quantities to fill up the vacant space inside the first sleeve. However, this approach has a drawback because this wide aperture cannot easily be closed except by means of a second sleeve that comes around this first cylindrical tube, this second sleeve being crimped on either side on the cables.

It is an object of the invention to overcome the problems referred to by proposing a single cylindrical coupling sleeve for which preferably a front end is designed to receive a first mineral-insulated cable while a rear end is designed to receive a matching device of the mineral-insulated cable. In the invention, the mineral-insulated cable is a coaxial cable. The matching device therefore is also a coaxial connector device.

The value of the invention is chiefly based on the fact that the coupling sleeve planned may be directly soldered to an external perimeter of the cable with mineral-insulated lining and also to an external perimeter of the matching device. The solder junction therefore has perfect hermetic sealing. Furthermore, in one variant, this sleeve provides for a means to be filled from a hole so as to fill a hollow space inside the tube in which the electrical contacts of the coaxial cable and the matching device respectively are connected. The space within the coupling sleeve is preferably filled with an insulating material. Another advantage of the invention is presented by the fact that the connection between the second coaxial contact of the cable and the second coaxial contact of the matching device is provided directly by means of the perimeter of the coupling sleeve.

The invention relates to a cylindrical coupling sleeve comprising a first entry with a first diameter adapted to being mounted on an external conductive perimeter of a first mineral-insulated coaxial cable, the sleeve comprising a second entry with a second diameter adapted to a matching coaxial device to be connected to the first cable, characterised in that the first entry and the second entry do not have the same internal diameters and may be soldered directly to the external perimeters of respectively the first mineral-insulated cable and the matching device.

The invention also relates to a method for the connection of a mineral-insulated coaxial cable with a coaxial device by means of a coupling sleeve characterised in that it comprises the following steps:

the mineral-insulated cable is partially stripped so as to have one end with at least one internal contact of the cable,

a rear part of the sleeve is placed around this end, the sleeve being in contact with an external conductive perimeter of this end,

the internal contact of this end is soldered to an internal contact of the coaxial device,

the sleeve is shifted along the external perimeter of the end of the cable so as to come to a stop against an external contact of the coaxial device,

edges of the sleeve are soldered respectively to the external perimeter of the end of the cable and the external contact of the coaxial device.

### BRIEF DESCRIPTION OF THE DRAWINGS

The invention will be understood more clearly from the following description and the accompanying figures. These figures are given purely by way of an indication and in no way restrict the scope of the invention. Of these figures:

FIG. 1 shows a longitudinal section of a coupling sleeve according to the invention;

FIG. 2 shows a longitudinal section of a coupling sleeve connected to a mineral-insulated coaxial cable according to a method of the invention.

### DETAILED DESCRIPTION OF THE PREFERRED EMBODIMENT(S)

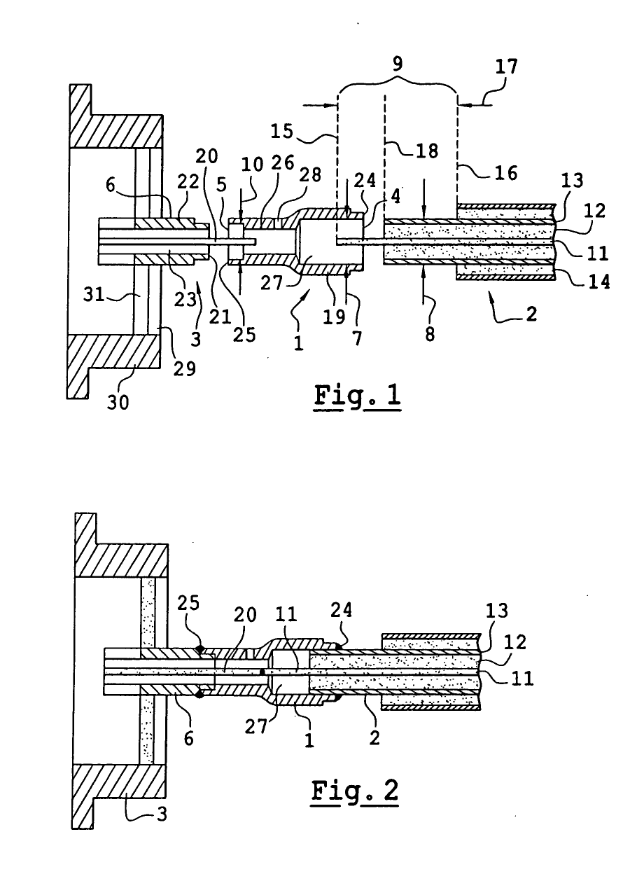

FIG. 1 shows a coupling sleeve 1. This coupling sleeve 1 is designed to be mounted on a mineral-insulated coaxial cable 2. The sleeve 1 is furthermore designed to be mounted on a matching coaxial device 3. The sleeve 1 has a generally cylindrical shape with a first entry 4 to receive the cable 2 therein, and a second entry 5 to receive therein a coaxial connector 6 presented by the coaxial device 3. For example, an internal diameter 7 of the first entry 4 is adapted to an external diameter 8 of a partially stripped front portion 9 of the cable 2. Similarly, the second entry 5 may have an inner diameter 10 adapted to an external diameter of the coaxial connector 6.

The coaxial cable 2 comprises several elements positioned concentrically from the centre to the periphery. There is a first electrical contact 11, made for example in the form of a wire or several assembled conductive strands. This first contact 11 is surrounded by a first insulating sheath 12. Preferably, this second insulating sheath 12 is made out of mineral material, for example ceramic or aluminium. The first contact 11 corresponds to an internal contact. It is made for example of copper. Around the first insulating sheath 12, a second coaxial contact 13 is formed. This second contact 13 is an external contact. It may be formed, for example, by a ferronickel layer surrounding an entire external perimeter of the insulating sheath 12. The first contact 11 and the second contact 13 form the two contacts provided by the coaxial cable 2.

The second coaxial contact 13 is itself insulated from the outside by a second insulating sheath 14. This second insulating sheath can also be made out of mineral material. The front end 9 is made by partial stripping from a front end 15 of the cable 2 up to a rear boundary 16 of this cable. The stripping is done in such a way that a length 17 along the longitudinal section axis of FIG. 1 is in the range of some centimetres. This front end 9 is stripped at two levels. On the whole, throughout the length 17, the second sheath 14 is stripped.

Furthermore, on a terminal end located between the front end 15 and an intermediate boundary 18, the second contact 13 as well as the first insulating sheath 12 are also stripped so as to reveal only the first contact 11 in this terminal end. In a rear part of the end 9, the second contact 13 is presented in the second sheath 14 and is therefore capable of being connected with a conductive element.

Once the cable 2 is stripped, a rear part 19 is placed on the first entry 4 side of the sleeve 1, around the end 9 of the cable 2. The sleeve 1 is shifted along the longitudinal section axis so that this sleeve 1 is pushed as far as possible around the end 9, and so as to thus let through at least one part of the front end presenting the first contact 11.

Facing this assembly, the matching connector 6 has the shape of a bush within which there is a first conductive contact 20. This first conductive contact 20 goes beyond a border 21 jointly formed by a second coaxial contact 22 and an insulating element 23 positioned between the first contact 20 and the second contact 23. The cable 2 provided with the sleeve 1 is then brought closer in such a way that the two free ends of the first contact 11 and of the first contact 20 can be connected. This connection is made, for example, by soldering.

Once this soldering is done, the sleeve 1 is moved from its first position to a second position, the second position being such that the sleeve entirely covers the part of the newly connected first contacts 11 and 20 respectively. Furthermore, this shifting of the sleeve is such that the sleeve 1, while remaining in contact with an external perimeter formed by the second contact 13, comes to a stop or abutment against an external perimeter of the second contact 22 of the matching connector 6. As soon as the sleeve 1 is truly in contact with the second contact 13 and the second contact 22, the external perimeter 24 of the first entry 4 is soldered to the second contact 13, and a second perimeter 25 of the second entry 5 is also soldered to the external perimeter of the second contact 22.

Preferably, the sleeve 1 comprises a shoulder means to cooperate with a matching shape of the connector 6. For example, this means corresponds to a shoulder in an internal wall 26 of the sleeve 1 on the second entry 5 side to cooperate with a matching form of the external perimeter of the second contact 22.

Thus, the two contacts of the coaxial cable are respectively connected with the two contacts of the coaxial connector 6. The useful aspect here is that the coupling sleeve can also be used as a conductor for the second contact.

In a particular embodiment, the matching device 5 is a mineral-insulated cable and, in this case, the structure of the coaxial connector 6 and especially that of the first contact 20, the insulating element 23 and the second contact 22 are similar to those of the cable 2.

To electrically insulate the first contact from the second contact, it is planned to fill an interior 27 of the coupling sleeve 1 with a dry, insulating material. To this end, the coupling sleeve 1 has an aperture 28 formed in its external perimeter, enabling the injection of an insulating material by means of a probe into the cavity 27. In a preferred embodiment, this aperture 28 has a relatively small diameter. The injection of the insulating material does not overflow into the entry 4 side and exit 5 side respectively because the respective external diameters are adjusted and the sleeve is force-fitted around these ends.

The aperture 28 may be closed with a drop of solder when the filling of the cavity 27 is completed. The cavity 27 is demarcated on either side by the first entry 4 and the second entry 5, slightly reduced by the fact that the cable 2 and the connector 6 respectively penetrate slightly into this cavity 27.

In a preferred embodiment, the connector 6 is mounted in a holder 3 which comprises, for example, a tightly impervious seal 29 around the connector 6 to hold it in a support 30 of the device 3. Furthermore the connector 6 may also be surrounded by a ceramic layer 31 in order that it may be retained in this same support 30.

Preferably, to perform the filling operation, first of all, the sleeve 1 is made to rotate about the longitudinal sectional axis in order to present the hole 28 upwards. The notion of an <<upwards>> direction means that the aperture 28 must be presented in such a way that the insertion of a filling means into this hole 28 enables the effective filling of the cavity 27. Indeed, the position of the aperture 28 must be such that, even when this aperture 28 is not plugged, the contents injected into the cavity 27 cannot come out of it by gravitational effect.

What is claimed is:

1- Cylindrical coupling sleeve comprising a first entry with a first diameter adapted to being mounted on an external conductive perimeter of a first mineral-insulated coaxial cable, the sleeve comprising a second entry with a second diameter adapted to a matching coaxial device to be connected to the first cable, characterised in that the first entry and the second entry do not have the same internal diameters and may be soldered directly to the external perimeters of the first mineral-insulated cable and the matching device respectively.

2- Sleeve according to claim 1 characterised in that it comprises a hole between the first entry and the second entry, to enable a filling of an internal space defined between these two entries, the hole being capable of being plugged after filling.

3- Sleeve according to claim 2 characterised in that the hole is plugged by a solder drop.

4- Sleeve according to claim 1 characterised in that the matching device is a coaxial connector held in a holder.

5- Method for the connection of a mineral-insulated coaxial cable with a coaxial device by means of a coupling sleeve characterised in that it comprises the following steps:
the mineral-insulated cable is partially stripped so as to have one end with at least one internal contact of the cable,
a rear part of the sleeve is placed around this end, the sleeve being in contact with an external conductive perimeter of this end,
the internal contact of this end is soldered to an internal contact of the coaxial device,
the sleeve is shifted along the external perimeter of the end of the cable so as to come to a stop against an external contact of the coaxial device,
edges of the sleeve are soldered respectively to the external perimeter of the end of the cable and the external contact of the coaxial device.

6- Method according to the claim 5 characterised in that
the sleeve is filled from an aperture of the sleeve with a dry, insulating material so as to fill up an interior space defined in the sleeve between the cable and the coaxial device.

7- Method according to the claim 6 characterised in that
the sleeve is positioned in such a way that the aperture of the sleeve is oriented upwards in order to prevent an overflow of the contents of the sleeve under the effect of gravitational forces.

8- Method according to claim 6 to characterised in that
the aperture of the sleeve is plugged, preferably after filling, by means of a solder.
